(19) United States
(12) Patent Application Publication
(10) Pub. No.: US 2024/0413429 A1
(43) Pub. Date: Dec. 12, 2024

(54) COOLING SYSTEM

(71) Applicant: TOYOTA JIDOSHA KABUSHIKI KAISHA, Toyota-shi (JP)

(72) Inventor: Yasuaki KODAMA, Seto-shi (JP)

(73) Assignee: TOYOTA JIDOSHA KABUSHIKI KAISHA, Toyota-shi (JP)

(21) Appl. No.: 18/639,280

(22) Filed: Apr. 18, 2024

(30) Foreign Application Priority Data
Jun. 8, 2023 (JP) 2023-094572

(51) Int. Cl. H01M 10/6567; B01J 20/26; H01M 10/613

(52) U.S. Cl. CPC H01M 10/6567; B01J 20/264; B01J 20/267; H01M 10/613

(57) ABSTRACT

In the present disclosure, there is provided a cooling system including a circulation path for circulating an insulating coolant of a non-aqueous system, and a coolant storage unit provided in the circulation path and storing the insulating coolant, wherein a specific gravity of the insulating coolant is smaller than that of water, and the coolant storage unit has a water removing portion therein, and the water removing portion is fixed to the coolant storage unit so that at least part of an upper surface of the water removing portion directly contacts the insulating coolant, thereby solving the problem.

### CROSS-REFERENCE TO RELATED APPLICATION

This application claims priority to Japanese Patent Application No. 2023-094572 filed on Jun. 8, 2023, incorporated herein by reference in its entirety.

### BACKGROUND

### 1. Technical Field

The present disclosure relates to cooling systems.

### 2. Description of Related Art

In a cooling system that circulates a coolant to cools electrical components such as a battery, high insulation properties are required for the coolant used. If water mixes into the coolant, the water may cause problems as short-circuiting between terminals of the electrical components and corrosion of components. In order to prevent an increase in electrical conductivity of the coolant, Japanese Unexamined Patent Application Publication No. 2022-158432 (JP 2022-158432 A), for example, discloses a technique of installing a water removing filter in a circulation path of a cooling system using a non-aqueous insulating coolant.

Japanese Unexamined Patent Application Publication No. 2001-050624 (JP 2001-050624 A) discloses a cooling device in which a water removing filter is disposed so as to close a coolant discharge portion of a coolant storage tank provided in a coolant circulation path. Japanese Unexamined Patent Application Publication No. 02-216855 (JP 02-216855 A) discloses a liquid cooling device for electrical and electronic components in which a water trapping material that can trap water in a cooling medium by reacting with the water is placed. Japanese Unexamined Patent Application Publication No. 2022-097321 (JP 2022-097321 A) discloses a water remover with a granular water-absorbing polymer enclosed in a wire mesh having a mesh structure, and Japanese Unexamined Patent Application Publication No. 2017-104817 (JP 2017-104817 A) discloses a method for removing water dispersed in an oil phase using water-absorbing resin powder enclosed in a resin net bag.

### SUMMARY

When a water removing portion is installed so as to close a coolant circulation path, the flow path resistance increases and the flow rate of a coolant decreases, which significantly reduces the cooling properties. Therefore, it is necessary to increase the output of a pressure pump in order to provide a high flow rate. In a non-aqueous coolant such as oil, water is often aggregated and present in the form of large water droplets. Therefore, if a water-absorbing resin is enclosed in a mesh, the water droplets may not be able to pass through the mesh and may not be able to reach the water-absorbing resin.

The present disclosure was made in view of the above circumstances, and it is an object of the present disclosure to provide a cooling system that can maintain high insulating properties of an insulating coolant while reducing circulating energy loss.

(1)

A cooling system includes a circulation path for circulating a non-aqueous insulating coolant, and a coolant storage unit located in the circulation path and storing the insulating coolant. The insulating coolant has a smaller specific gravity than water. The coolant storage unit contains a water removing portion. The water removing portion is fixed to the coolant storage unit in such a manner that at least part of an upper surface of the water removing portion directly contacts the insulating coolant.

(2)

In the cooling system according to (1), at least part of the water removing portion may be fixed to a bottom surface of the coolant storage unit.

(3)

In the cooling system according to (1) or (2), the water removing portion may contain a porous zeolite or a water-absorbing resin as a water absorber.

(4)

In the cooling system according to (3), the water-absorbing resin may be at least one selected from the group consisting of: a crosslinked partially neutralized polyacrylic acid, a neutralized starch-acrylic acid graft polymer, a hydrolyzed starch-acrylonitrile graft polymer, a saponified vinyl acetate-acrylic acid ester copolymer, a crosslinked isobutylene-maleic anhydride copolymer, a hydrolyzed acrylonitrile copolymer, a hydrolyzed acrylamide copolymer, a crosslinked hydrolyzed acrylonitrile copolymer, a crosslinked hydrolyzed acrylamide copolymer, a crosslinked acrylate-acrylamide copolymer, a crosslinked polyvinyl alcohol, a crosslinked modified polyethylene oxide, a crosslinked acrylamide-2-methylpropanesulfonate copolymer, a crosslinked (meth)acryloylalkanesulfonate copolymer, a crosslinked carboxymethylcellulose salt, and a crosslinked polymer of cationic monomers.

(5)

In the cooling system according to (3) or (4), the water-absorbing resin may be a crosslinked partially neutralized polyacrylic acid or a neutralized starch-acrylic acid graft polymer.

The cooling system according to the present disclosure can advantageously maintain high insulating properties of an insulating coolant while reducing circulating energy loss.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating an example of a cooling system according to the present disclosure;

FIG. 2 is a schematic sectional view illustrating an example of a coolant storage unit according to the present disclosure;

FIG. 3A is a schematic sectional view illustrating a coolant storage unit according to an embodiment of the present disclosure.

FIG. 3B is a schematic sectional view illustrating another exemplary coolant storage unit according to the present disclosure;

FIG. 4 is a schematic cross-sectional view illustrating another exemplary coolant storage unit according to the present disclosure; and

FIG. 5 is a schematic cross-sectional view illustrating an example of a coolant storage unit in which a conventional water removing portion is disposed.

### DETAILED DESCRIPTION OF EMBODIMENTS

Hereinafter, the cooling system according to the present disclosure will be described in detail.

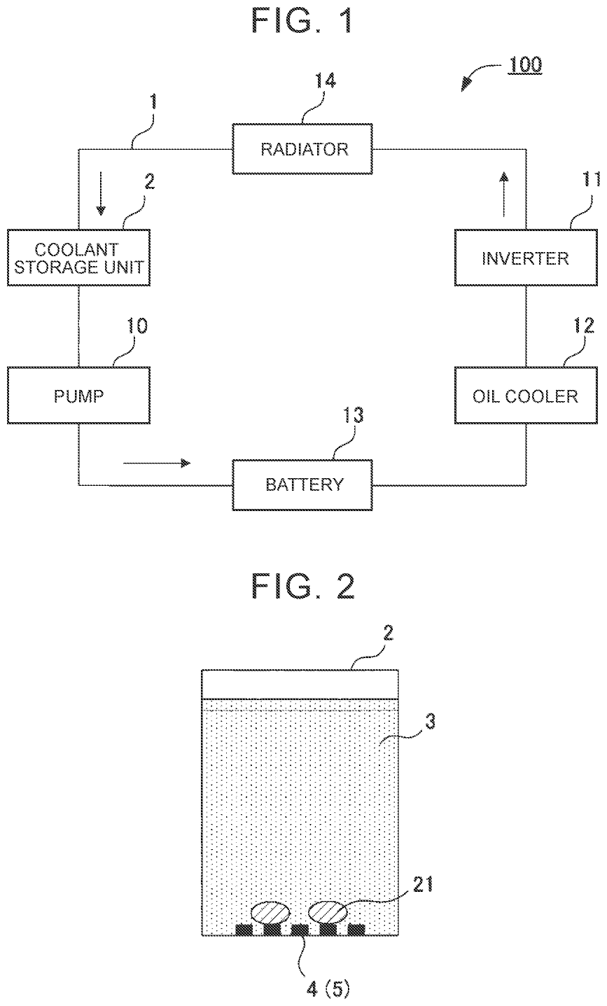

FIG. 1 is a schematic configuration diagram illustrating an example of a cooling system of the present disclosure. The cooling system 100 illustrated in FIG. 1 includes a circulation path 1 for circulating a non-aqueous insulating coolant, and a coolant storage unit 2 provided in the circulation path 1 for storing the insulating coolant. The flow of the insulating coolant in the circulation path 1 can be formed by using the pump 10 or the like. The cooling system 100 of the present disclosure can be mounted on a vehicle, for example, and can be used to cool a heating device such as an inverter 11, an oil cooler 12, and a battery 13 provided in series in the circulation path 1. By providing the radiator 14 in the circulation path 1 and performing heat exchange with the outside air, it is possible to cool the heat generating device and cool the insulating coolant that has been heated.

FIG. 2 is a schematic sectional view showing an example of a coolant storage unit according to the present disclosure. The water removing portion 4 is fixed to the coolant storage unit 2 so that at least a part of the upper surface thereof is in direct contact with the insulating coolant 3. Since the specific gravity of the insulating coolant 3 used in the present disclosure is smaller than that of water, the moisture mixed in the insulating coolant 3 sinks in the coolant storage unit 2, becomes a droplet 21 by aggregation, is absorbed by the water removing portion 4 (water absorber 5), and is removed from the insulating coolant 3.

In the cooling system of the present disclosure, at least a part of the upper surface of the cooling system is in direct contact with the insulating coolant, and the water removing portion is fixed to the coolant storage unit, whereby the water in the insulating coolant can be efficiently removed without stagnating the flow of the insulating coolant in the circulation path. Therefore, the insulating property of the insulating coolant can be maintained high while suppressing the circulating energy loss.

When the water removing portion is installed in such a manner as to block the circulation path of the coolant and the entrance and the exit of the coolant storage unit so that all the coolant passes through the water removing portion, the flow resistance of the coolant increases, and the flow rate of the coolant decreases and the cooling property greatly decreases. Therefore, it is necessary to increase the output of the pumping pump to ensure the flow rate. On the other hand, as described above, in the present disclosure, since the insulating coolant having a specific gravity smaller than that of water is used, the water mixed in the insulating coolant sinks in the coolant storage unit and collects at the bottom portion of the coolant storage unit. Therefore, by disposing the water removing portion at a place where the water droplets of the coolant storage unit collect and absorbing the moisture, the moisture can be removed from the insulating coolant without increasing the output of the pumping pump.

In addition, in a non-aqueous coolant such as oil, if a water absorber is enclosed in a bag or the like having a mesh structure, large water droplets that are aggregated cannot pass through the mesh and may not reach the water-absorbing resin. On the other hand, in the present disclosure, since the water removing portion is fixed to the coolant storage unit so that at least a portion of the upper surface thereof is in direct contact with the insulating coolant, the water droplets can be smoothly and quickly absorbed without being blocked by a structure such as a mesh bag interposed between the water absorber of the water removing portion and the insulating coolant.

A cooling system according to the present disclosure includes a circulation path for circulating an insulating coolant, and a coolant storage unit for storing the insulating coolant. Hereinafter, each configuration of the cooling system according to the present disclosure will be described.

### 1. Insulating Coolant

The insulating coolant used in the present disclosure is not particularly limited as long as it has a specific gravity smaller than that of water and is a non-aqueous and insulating liquid. For example, a mineral oil containing a hydrocarbon compound such as an aromatic hydrocarbon, a paraffinic hydrocarbon, or a naphthenic (cycloalkane) hydrocarbon can be used.

### 2. Circulation Path

The circulation path in the cooling system of the present disclosure is a path for circulating the insulating coolant. The circulation path is not particularly limited as long as the insulating coolant has a pipe for circulating between the object to be cooled and the coolant storage unit, and a general pipe similar to a pipe for circulating lubricating oil or the like can be used.

### 3. Coolant Storage Unit

The coolant storage unit is provided in the circulation path and stores the insulating coolant. The material, shape, size, and the like of the coolant storage unit are not particularly limited as long as the coolant storage unit can store the insulating coolant therein. For example, it can be appropriately set in accordance with the shape of the place where the coolant storage unit is disposed, the amount of the insulating coolant stored therein, and the like, such as a rectangular parallelepiped or cylindrical container made of resin or metal.

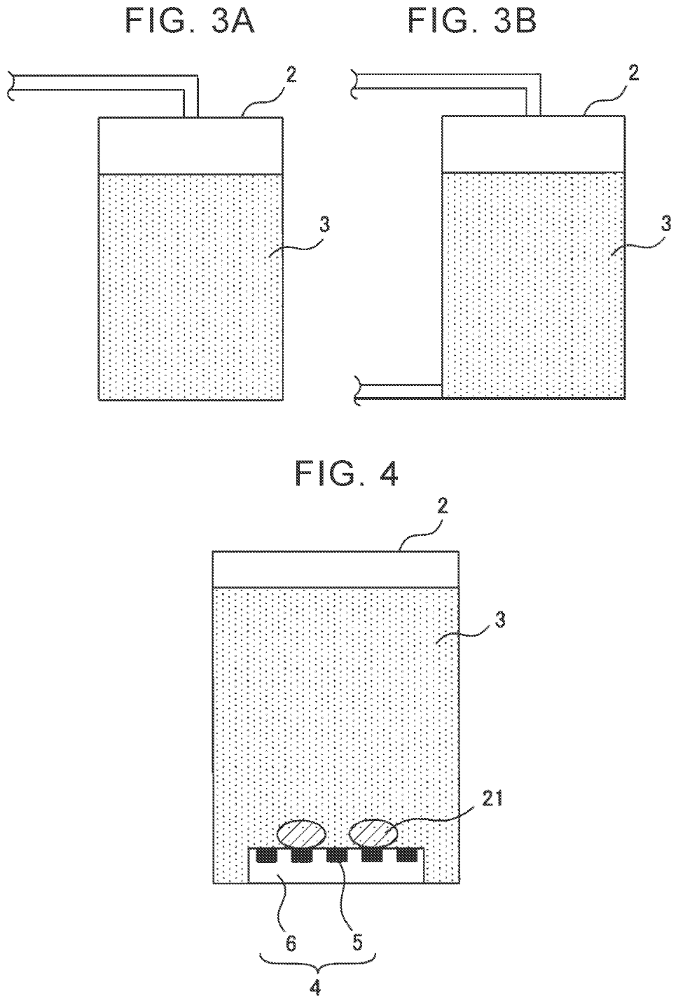

The type of the coolant storage unit is not particularly limited, and for example, a one-port container (see FIG. 3A) such as a pressurized reservoir tank of a radiator can be used. Also, a two-port container as illustrated in FIG. 3B may be used. In the case of a two-port container, as in the case of an open-air type reserve tank, one port may be open to the atmosphere, and the insulating coolant may be introduced/discharged from the other port, or may be a circulation type container in which the insulating coolant flows in from one port and is discharged from the other port.

A water removing portion is fixed inside the coolant storage unit. The arrangement position of the water removing portion in the coolant storage unit is not particularly limited as long as it does not hinder the flow of the insulating coolant, and can be arranged on the bottom surface or the side surface of the coolant storage unit so as not to block the inlet and the outlet of the insulating coolant. In particular, it is preferable that at least a portion of the water removing portion is disposed on a bottom surface of the coolant storage unit. This is because it is possible to efficiently absorb water droplets that have settled on the bottom surface of the coolant storage unit due to the difference in specific gravity. At this time, the water removing portion may be disposed only on part of the bottom surface of the coolant storage unit or may be disposed on the entire bottom surface.

The fixing of the water removing portion to the coolant storage unit can be performed by fixing the water absorber of the water removing portion directly or indirectly to the coolant storage unit. For example, when the water absorber of the water removing portion is a pellet-like or block-like material having a size equal to or larger than 5 mm, as illustrated in FIG. 2, the water removing portion 4 composed only of the water absorber 5 can be directly adhered and fixed to the bottom surface of the coolant storage unit 2 or the like. When the size of the pellets or blocks of the water absorber is small, the surface area is large, and thus high water absorption performance can be exhibited. On the other hand, when the size of the pellets or blocks of the water absorber is large, high adhesiveness can be exhibited. Therefore, the size of the water absorber is preferably small enough to exhibit stable adhesiveness, and can be appropriately selected and used depending on characteristics required for the water removing portion.

Further, when the water absorber is a powdery or particulate material having a size less than 5 mm, as illustrated in FIG. 4, the water absorber 5 is dispersed in a resin piece (resin filling portion 6), and the resin filling portion 6 including the water absorber 5 is adhered and fixed to the bottom surface of the coolant storage unit 2 or the like, whereby the water absorber 5 can be indirectly fixed to the coolant storage unit 2. In the case where the water removing portion includes the water absorber and the resin filling portion, the water absorber is disposed so that at least a part of the surface of the water absorber is exposed to the surface (upper surface) of the resin filling portion. By disposing such a water removing portion so as to be immersed in the insulating coolant, the water absorber can be brought into direct contact with the insulating coolant.

Examples of the water absorber include porous zeolites such as molecular sieves and water-absorbing resins. Examples of the water-absorbing resin include a crosslinked partially neutralized polyacrylic acid, a neutralized starch-acrylic acid graft polymer, a hydrolyzed starch-acrylonitrile graft polymer, a saponified vinyl acetate-acrylic acid ester copolymer, a crosslinked isobutylene-maleic anhydride copolymer, a hydrolyzed acrylonitrile copolymer, a hydrolyzed acrylamide copolymer, a crosslinked hydrolyzed acrylonitrile copolymer, a crosslinked hydrolyzed acrylamide copolymer, a crosslinked acrylate-acrylamide copolymer, a crosslinked polyvinyl alcohol, a crosslinked modified polyethylene oxide, a crosslinked acrylamide-2-methylpropanesulfonate copolymer, a crosslinked (meth)acryloylalkanesulfonate copolymer, a crosslinked carboxymethylcellulose salt, and a crosslinked polymer of cationic monomers. A crosslinked partially neutralized polyacrylic acid and a neutralized starch-acrylic acid graft polymer are particularly suitable among these.

The resin used in the resin filling portion is not particularly limited as long as it has resistance to an insulating coolant, and for example, a thermosetting resin such as an epoxy resin, a polyfunctional cyanate ester resin, a polyfunctional maleimide-cyanate ester resin, a polyfunctional maleimide resin, an unsaturated polyester resin, or an unsaturated group-containing polyphenylene ether resin can be used.

### 4. Cooling System

Applications of the disclosed cooling system are not particularly limited, but may be used for cooling batteries, inverters, oil coolers, and the like of vehicles such as hybrid electric vehicle (HEV), plug-in hybrid electric vehicle (PHEV), battery electric vehicle (BEV), gasoline-powered vehicles, and diesel-powered vehicles. In addition, the cooling system of the present disclosure may be used to cool electric-related components such as a moving body (for example, a railway, a ship, an aircraft), a machine tool, an information processing apparatus, and the like other than a vehicle.

In the cooling system, a pumping pump for generating a circulating flow of the insulating coolant and a heat exchanger such as a radiator for lowering the temperature of the insulating coolant after cooling the object to be cooled may be arranged. Further, the circulation path may be provided with a sensor for measuring the temperature, conductivity, moisture content, and the like of the insulating coolant, a notification unit for notifying the surroundings of the fact when the measured value exceeds the threshold, a control unit for controlling these components, and the like.

The present disclosure is not limited to the above embodiments. The above embodiments are illustrative, and anything having substantially the same configuration as, and having similar functions and effects to, the technical idea described in the claims of the present disclosure is included in the technical scope of the present disclosure.

### Example 1

As exemplified in FIG. 2, the non-aqueous insulating coolant 3 was filled in the coolant storage unit 2 having the water removing portion 4 to which the water-absorbing resin as the water absorber 5 was adhered and fixed to the bottom surface of the coolant storage unit 2, and the water droplets 21 were added thereto and left standing for a certain period of time.

### Example 2

As exemplified in FIG. 4, the water removing portion 4, on the upper surface of the resin filling portion 6, the water-absorbing resin as the water absorber 5 is exposed, the coolant storage unit 2 fixed to the bottom surface, filled with the non-aqueous insulating coolant 3, water droplets 21 were added, and left for a certain period of time.

### Comparative Example

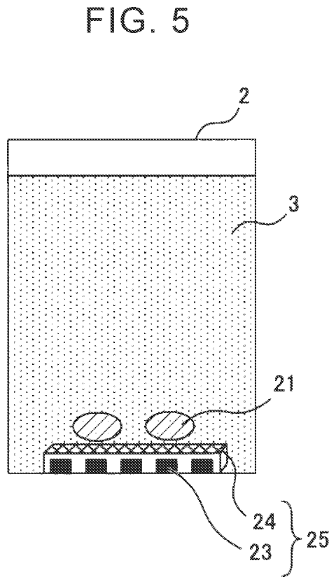

As exemplified in FIG. 5, on the bottom surface of the coolant storage unit 2, the water-absorbing resin as the water absorber 23 was filled with the non-aqueous insulating coolant 3 in the coolant storage unit 2 having the water removing portion 25 sealed in the mesh bag 24 having a mesh of about 1 mm, and the water droplets 21 were added thereto and allowed to stand for a certain period of time.

### Evaluation

In Example 1 and Example 2, the water droplets were submerged by the specific gravity difference and reached the upper surface of the water removing portion, and were absorbed by the water absorber, and the moisture in the insulating coolant was removed. On the other hand, in the comparative example, the water droplets reached the upper surface of the water removing portion in the same manner as in Example 1 and Example 2, but the water droplets remained on the water removing portion, and were not absorbed by the water removing portion, so that the moisture in the insulating coolant could not be removed. This is presumed to be because the surface tension is stronger than the force that the water droplets settle in the mesh bag due to their own weight, and the water droplets cannot pass through the mesh structure and cannot reach the surface of the water absorber in the mesh bag.

What is claimed is:

1. A cooling system including a circulation path for circulating a non-aqueous insulating coolant, and a coolant storage unit located in the circulation path and storing the insulating coolant,
the insulating coolant having a smaller specific gravity than water,
the coolant storage unit containing a water removing portion, and
the water removing portion being fixed to the coolant storage unit in such a manner that at least part of an upper surface of the water removing portion directly contacts the insulating coolant.

2. The cooling system according to claim 1, wherein at least part of the water removing portion is fixed to a bottom surface of the coolant storage unit.

3. The cooling system according to claim 1, wherein the water removing portion contains a porous zeolite or a water-absorbing resin as a water absorber.

4. The cooling system according to claim 3, wherein the water-absorbing resin is at least one selected from the group consisting of: a crosslinked partially neutralized polyacrylic acid, a neutralized starch-acrylic acid graft polymer, a hydrolyzed starch-acrylonitrile graft polymer, a saponified vinyl acetate-acrylic acid ester copolymer, a crosslinked isobutylene-maleic anhydride copolymer, a hydrolyzed acrylonitrile copolymer, a hydrolyzed acrylamide copolymer, a crosslinked hydrolyzed acrylonitrile copolymer, a crosslinked hydrolyzed acrylamide copolymer, a crosslinked acrylate-acrylamide copolymer, a crosslinked polyvinyl alcohol, a crosslinked modified polyethylene oxide, a crosslinked acrylamide-2-methylpropanesulfonate copolymer, a crosslinked (meth)acryloylalkanesulfonate copolymer, a crosslinked carboxymethylcellulose salt, and a crosslinked polymer of cationic monomers.

5. The cooling system according to claim 4, wherein the water-absorbing resin is a crosslinked partially neutralized polyacrylic acid or a neutralized starch-acrylic acid graft polymer.
